(19) United States
(12) Patent Application Publication
(10) Pub. No.: US 2012/0210067 A1
(43) Pub. Date: Aug. 16, 2012

(54) MIRRORING DEVICE AND MIRRORING RECOVERY METHOD

(75) Inventor: Koji ABUMI, Yamanashi (JP)

(73) Assignee: NEC Computertechno, Ltd., Kofu-shi (JP)

(21) Appl. No.: 13/370,024

(22) Filed: Feb. 9, 2012

(30) Foreign Application Priority Data
Feb. 14, 2011 (JP) 28138/2011

(51) Int. Cl. G06F 12/16; G06F 12/08

(52) U.S. Cl. 711/118; 711/E12.017; 711/E12.103

(57) ABSTRACT

To provide a mirroring device which does not need a competition control function dedicated for a restoring process without halting other access commands during the restoring process of a mirroring.

The mirroring device includes a pair of storage devices, a mirroring control unit which duplicates write data in the storage device in the case that a pair of storage devices are in a normal state and writes data in an available storage device in the case of a reduced state, a cache unit which stores input and output data and rewrites target data to be rewritten in the pair of storage devices, and a mirroring recovery unit which readouts date to the cache unit from the available storage device in the reduced state and recovers duplication of data by rewriting to the pair of storage devices when recovering from the reduced state to the normal state.

This application is based upon and claims the benefit of priority from Japanese Patent Application No. 2011-028138, filed on Feb. 14, 2011, the disclosure of which is incorporated herein in its entirety by reference.

### TECHNICAL FIELD

The present invention relates to a storage device and in particular a mirroring device with a mirroring configuration of duplicated data and a mirroring recovery method.

### BACKGROUND ART

Various mirroring technologies of duplicating data in the storage device are known. Information processing equipment which adopted the mirroring technology includes a pair of storage devices (i.e. two storage devices) in order to duplicate and store data. And, the information processing equipment which adopted the mirroring technology reads data from one of the storage devices and writes data in both storage devices in a normal state in the case that both storage devices normally operate. And, when a failure occurs in one of the storage devices, the information processing equipment is in a reduced state where it reads and writes data using a normal storage device. Then, when the failed storage device is replaced with a new one, the information processing equipment at the reduced state recovers from the reduced state to the normal state. During the recovery, the information processing equipment copies data in the normal storage device to the replaced storage device and recovers the mirroring configuration of data of the storage devices. An example of the mirroring recovery process device which executes a mirroring recovery process is disclosed in Japanese Patent Application Laid-Open No. 2010-244241 (the patent document 1).

The information processing equipment disclosed in the patent document 1 needs to avoid a competition between copying data from the normal storage device to the replaced storage device during a restoring process of the mirroring and accessing to the storage device during a usual process of the information processing equipment. In order to avoid the competition, the information processing equipment needs to halt a part of access commands to the storage device during the restoring process of the mirroring. However, the halt of the access commands causes a performance degradation of the information processing equipment. Alternatively, in order to avoid the halt the access commands during the restoring process, the information processing equipment needs to have a competition control function for controlling so that target data for the data copy while the restoring process and data of the access of the usual process are not competed.

In other words, if the competition control function dedicated for the restoring process is prepared, the information processing equipment described in the patent document 1 has a problem of degrading the performance.

### SUMMARY

The present invention was invented in view of the above-mentioned technical problems, and an object is to provide a mirroring device and a mirroring recovery method which do not halt other access commands during the restoring process of the mirroring without having a competition control function dedicated for the restoring process.

A mirroring device of the present invention includes a pair of storage devices, a mirroring control unit which duplicates and stores write data in said pair of storage devices and reads readout data from one of said pair of storage devices in the case of a normal state where both of said pair of storage devices are available, and stores said write data in an available storage device and reads the readout data from said available storage device in the case of a reduced state where it cannot use one of said pair of storage devices, a cache unit which stores input and output data to said pair of storage devices, reads and stores the data from one of said pair of storage devices via said mirroring control unit in the case that it does not store said readout data, and rewrites the target data to be rewritten in said pair of storage devices via said mirroring control unit, and a mirroring recovery unit which reads out a data from an available storage device in said reduced state to said cache unit and rewrites the readout data in said pair of storage devices when said mirroring control unit recovers from said reduced state to said normal state and recovers duplication of data.

In addition, a mirroring recovery method according to the present invention is provided, wherein inputting readout data from and outputting write data to an available storage device in the case of a reduced state where it cannot use one of a pair of storage devices, and duplicating and storing write data in said pair of storage devices and reading readout data from one of said storage devices in the case of a normal state where both of said pair of storage devices are available, and reading recovery target data to said cache unit from the storage device used in said reduced state, and duplicating and rewriting the data in said cache unit to said pair of storage devices, when there is no said recovery target data in the cache unit which stores the input and output data to said pair of storage devices in the case of recovering from said reduced state to normal state.

### BRIEF DESCRIPTION OF THE DRAWING

Exemplary features and advantages of the present invention will become apparent from the following detailed descriptions when taken with the accompanying drawings in which:

FIG. 1 is a block diagram showing an example of a configuration of a mirroring device of a first exemplary embodiment of the present invention.

FIG. 2 is a flowchart showing an example of processes of the first exemplary embodiment of the present invention.

FIG. 3 is a block diagram showing an example of a configuration of the mirroring device of a second exemplary embodiment of the present invention.

FIG. 4 is a flowchart showing an example of processes of the second exemplary embodiment of the present invention.

FIG. 5 is a block diagram showing an example of a configuration of the mirroring device of a third exemplary embodiment of the present invention.

### EXEMPLARY EMBODIMENT

Hereinafter, it will describe each exemplary embodiment of the present invention. Further, following exemplary embodiments of the present invention will describe examples when it applies a main storage device (hereinafter, it denotes “memory”) as a pair of storage devices (i.e. two storage devices) according to the present invention.

### First Exemplary Embodiment

At first, it will describe the first exemplary embodiment of the present invention in detail with reference to the drawings.

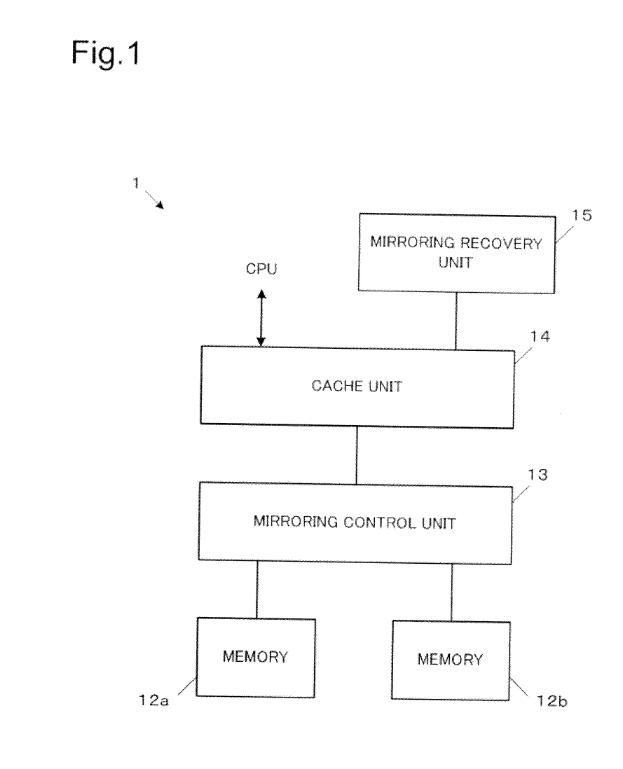

FIG. 1 shows the example of configuration of a mirroring device 1 according to the first exemplary embodiment of the present invention. The mirroring device 1 in FIG. 1 describes the configuration related to the present invention. In FIG. 1, the mirroring device 1 includes a memory 12a, a memory 12b, a mirroring control unit 13, a cache unit 14, and a mirroring recovery unit 15. And, the mirroring device 1 is connected with a CPU (Central Processing Unit) as an example of the upper device (host processor) via a bus. The CPU can be included in a computer which includes the mirroring device 1.

The memory 12a and the memory 12b compose a pair of storage devices in the exemplary embodiment of the present invention. The memory 12a and the memory 12b store duplicated data by a control of the mirroring control unit 13 which will be described later. And, the memory 12a and the memory 12b function as an RAM (Random Access Memory) of the computer which includes the mirroring device 1. That is, the CPU which is the upper device writes computer programs and data from auxiliary storage devices, ROMs (Read Only Memory) or peripheral equipment, which are not illustrated, to the memory 12a and to the memory 12b, and executes various processes using the written computer programs and the data. The memory 12a and the memory 12b can be composed of such as semiconductor memories consisting of DRAMs (Dynamic Random Access Memory).

When both the memory 12a and the memory 12b are available, the mirroring control unit 13 operates in a normal state. (Hereinafter, “normal state” denotes a state that both of a pair of storage devices can be used.) Specifically, the mirroring control unit 13 duplicates and stores write data received from the CPU to the memory 12a and the memory 12b in the normal state. That is, when the mirroring control unit 13 receives a write command of data, it respectively issues a write command to the memory 12a and the memory 12b.

And, the mirroring control unit 13 reads data in response to a read request received from the CPU from one of the memory 12a or the memory 12b in the normal state. That is, the mirroring control unit 13 reads data from one of the memory 12a or the memory 12b when it receives a read command of data.

Alternatively, when it cannot use one of the memory 12a or the memory 12b, the mirroring control unit 13 operates in a reduced state. (Hereinafter, “reduced state” denotes a state that one of a pair of storage devices cannot be used.) Specifically, in the reduced state, the mirroring control unit 3 reads data in response to a request of the CPU from an available memory among the memory 12a or the memory 12b and writes the write data from the CPU to the memory 12a or the memory 12b. For example, when a failure occurs in one of the memory 12a or the memory 12b, the mirroring control unit 13 activates in the reduced state.

The cache unit 14 temporarily stores input and output data transmitted between the CPU and the memory 12a and the memory 12b.

Further, when the cache unit 14 is not storing data in response to a read request received from the CPU (i.e. target data in response to the read command), it reads and stores the data from one of the memory 12a or the memory 12b via the mirroring control unit 13. Specifically, the cache unit 14 executes as the following descriptions. The cache unit 14 transmits a read command of read request received from the CPU to the mirroring control unit 13. Then, the cache unit 14 receives target data in response to the read command from the mirroring control unit 13 and stores the received data. Further, when the cache unit 14 already stores target data in response to the read command, it does not transmit the read command to the mirroring control unit 13.

Moreover, the cache unit 14 rewrites target data to be rewritten to the memory 12a and the memory 12b via the mirroring control unit 13. For example, when the cache unit 14 is not storing target data in response to a read command and has no areas for storing new data, it determines data to be expelled (i.e. swapped out) from the cache unit 14 among data which are being already stored according to a predetermined cache algorithm. Then, in the case that the data of the determined target to be expelled is in “update completion state” meaning that it is updated after read from the memory 12a or the memory 12b, the cache unit 14 issues a write command for rewriting to the memory 12a and to the memory 12b to the mirroring control unit 13. The mirroring control unit 13 rewrites the data to the memory 12a and the memory 12b based on the write command from the cache unit 14. As the result, the rewritten (i.e. swapped out) data is duplicated and is stored both in the memory 12a and the memory 12b. After the data is rewritten, the cache unit 14 deletes the data in the cache unit 14 and reserves a storage area for saving data.

And, when the cache unit 14 receives a non-update write command which will be mentioned later, it reads target data in response to the non-update write command from one of the memory 12a or the memory 12b via the mirroring control unit 13 and temporarily stores it. At that time, the cache unit 14 changes a state of the readout data into the update completion state. However, when the cache unit 14 is already storing target data in response to the received non-update write command, it omits a reading from the memory 12a or the memory 12b. Then, the cache unit 14 changes a state of the stored target data into the update completion state even though it is not updating. Further, the non-update write command means a write command without updating after the reading.

The mirroring recovery unit 15 controls recovery of data of the mirroring configuration of the memory 12a and the memory 12b, when the mirroring device 1 recovers from the reduced state to the normal state. For an example, the mirroring recovery unit 15 may start processes of the mirroring recovery when it acquires information indicating that a failed memory among the memory 12a or the memory 12b is replaced. Specifically, the mirroring recovery unit 15 issues the above-mentioned non-update write command to each data in the memory space which correspond to the memory 12a and to the memory 12b. This non-update write command is executed by the cache unit 14. Based on the process, the mirroring recovery unit 15 registers data stored in the memory among the memory 12a or the memory 12b which is used during the reduced state to the cache unit 14. Here, the registration in the cache unit 14 means that the cache unit 14 reads and stores data. However, the mirroring recovery unit 15 omits reading from the memory 12a or the memory 12b which is used in the reduced state about data which are already stored in the cache unit 14. (The cache unit 14 may execute the omitting judgment as it has already described.) After that, the cache unit 14 rewrites target data for rewritten to the memory 12a and the memory 12b via the mirroring control unit 13.

That is, the cache unit 14 stores (i.e. memorizes) data stored in the memory 12a or the memory 12b which is used in the reduced state as an update completion state based on the non-update write command. Because these data are in the update completion state, the mirroring control unit 13 duplicates and rewrites them to both the memory 12a and the memory 12b when the cache unit 14 selects these data as targets to be rewritten.

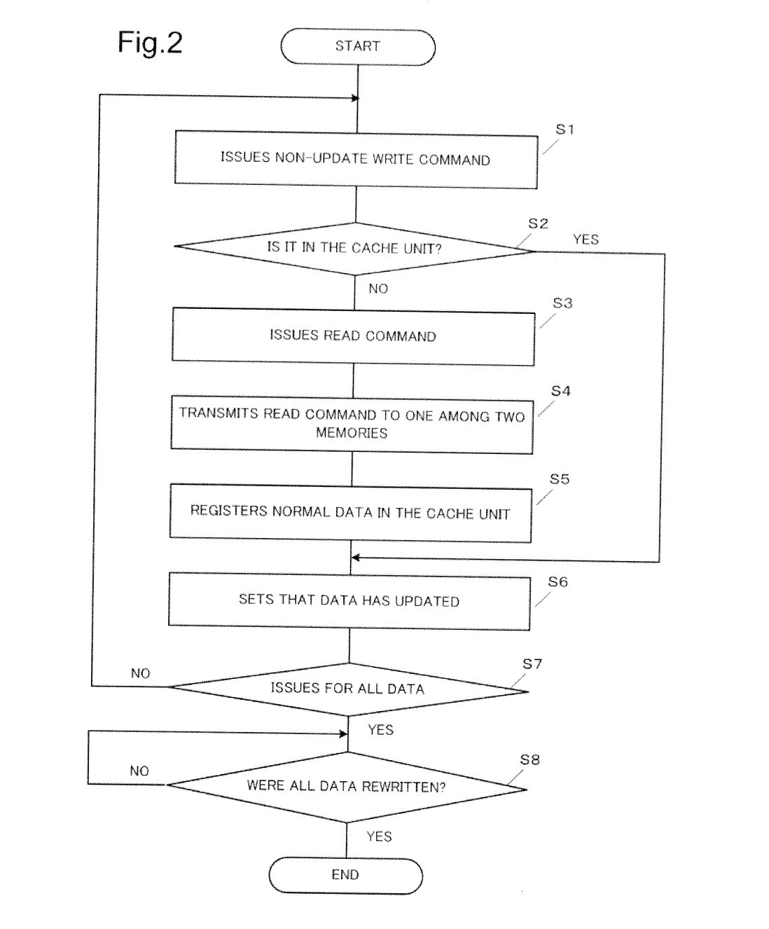

It will describe the mirroring recovery process of the mirroring device 1 based on above-mentioned configuration with referring to FIG. 2. Further, as an example of the recovery process, it will describe the following processes for the mirroring device 1 supposing that a state is shifted from the reduced state where the memory 12b cannot be used due to a failure and the memory 12a can be used, to a state where the memory 12b is replaced with a new memory 12b and both the memory 12a and the memory 12b became available. And, the mirroring device 1 executes processes in response to a read commands and a write commands received from the CPU during the following processes.

The mirroring device 1 executes processes of Steps S1-S6 for each data stored in the memory space which correspond to the memory 12a and the memory 12b.

The mirroring recovery unit 15 notifies the cache unit 14 of a non-update write command of recovery target data (Step S1).

When the cache unit 14 already stores data in response to the non-update write command (Yes in Step S2), it skips the processes of Steps S3-S5 and sets the data into the update completion state (Step S6).

On the other hand, when the cache unit 14 is not storing data in response to a non-update write command (No in Step S2), it notifies the mirroring control unit 13 of a read command of data (Step S3).

Further, when there are no areas for storing new data in the cache unit 14, the cache unit 14 notifies the mirroring control unit 13 of a write command of target data to be rewritten before notifying the mirroring control unit 13 of a read command. Then, the cache unit 14 notifies the mirroring control unit 13 of a read command of data after it can reserve a storage area by the rewriting.

The mirroring control unit 13 notifies the memory 12a which is used in the reduced state of a read command (Step S4).

The mirroring control unit 13 returns data received from the memory 12a to the cache unit 14 (Step S5).

The cache unit 14 stores the data returned from the mirroring control unit 13 and sets into the update completion state (Step S6).

Here, when the mirroring device 1 has not completed the processes of Steps S1-S6 for all data of recovery target in the memory space (No in Step S7), it repeats the processes from Step S1 for a next data.

Further, the cache unit 14 receives read commands and write commands from the CPU while executing these mirroring recovery. Then, the cache unit 14 notifies the mirroring control unit 13 of a write command of the target data to be rewritten when rewriting is needs at a process of a command from the CPU, a process of a non-update write command from the mirroring recovery unit 15, or a predetermined timing. Because both the memory 12a and the memory 12b are already in an available state, the mirroring control unit 13 duplicates and rewrites the target data to be written to both the memory 12a and the memory 12b.

Then, the mirroring device 1 completes the mirroring recovery process after the process of Steps S1-S6 have completed for all data of the recovery target (Yes in Step S7), and all data which are updated by the cache unit 14 based on issuing non-update write commands which are issued in Step S1 are rewritten to the memory 12a and the memory 12b (Yes in Step S8).

Next, it will describe an effect according to the first exemplary embodiment of the present invention.

Because the mirroring device 1 according to the first exemplary embodiment of the present invention does not need to halt other access commands during the restoring process of the mirroring, it can dispense the competition control function dedicated for the restoring process.

This is because the mirroring recovery unit 15 issues a non-update write command to the cache unit 14. The cache unit 14 reads data from the storage device (i.e. memory) which is used in the reduced state via the mirroring control unit 13 based on the non-update write command, and stores the data as the update completion state. Because of the update completion state, when the cache unit 14 requests the mirroring control unit 13 to write data which are readout, the mirroring control unit 13 duplicates and writes the data to the pair of storage devices. In other words, the mirroring device 1 can achieve copying of data from the storage device used at the reduced state to the other storage device which could be newly used by replacing or the like.

Further, the cache unit 14 does not newly readout data which are being already stored in the cache unit 14. This is due to the following reason. Those data which existing in the cache unit 14 in the reduced state are accessed from the upper device (host processor). These data are the same data stored in the storage devices or updated data. In other words, data stored in the storage devices are the same data stored in the cache unit 14 or older data. Therefore, the cache unit 14 does not copy data in the storage device to data stored in the cache unit 14. Then, the cache unit 14 writes new data which exist in the cache unit 14 to both of the pair of storage devices.

In this way, the mirroring device 1 according to the first exemplary embodiment of the present invention does not need to have the competition control function for a competition between data which are accessing target for the usually process and data which are copy target of the restoring process, even though it is under the restoring process of the mirroring.

In other words, an exemplary advantage of the first exemplary embodiment of the present invention is that the first exemplary embodiment can provide a mirroring device wherein it does not need to halt other access commands during a restoring process of the mirroring without using a competition control function.

### Second Exemplary Embodiment

Next, it will describe a second exemplary embodiment of the present invention in detail with reference to the drawings. Further, in each drawing referred by the descriptions of the exemplary embodiment, it attaches a same mark to similar elements in the configurations and to steps of the similar processes as the first exemplary embodiment of the present invention, and omits detailed descriptions in the exemplary embodiment.

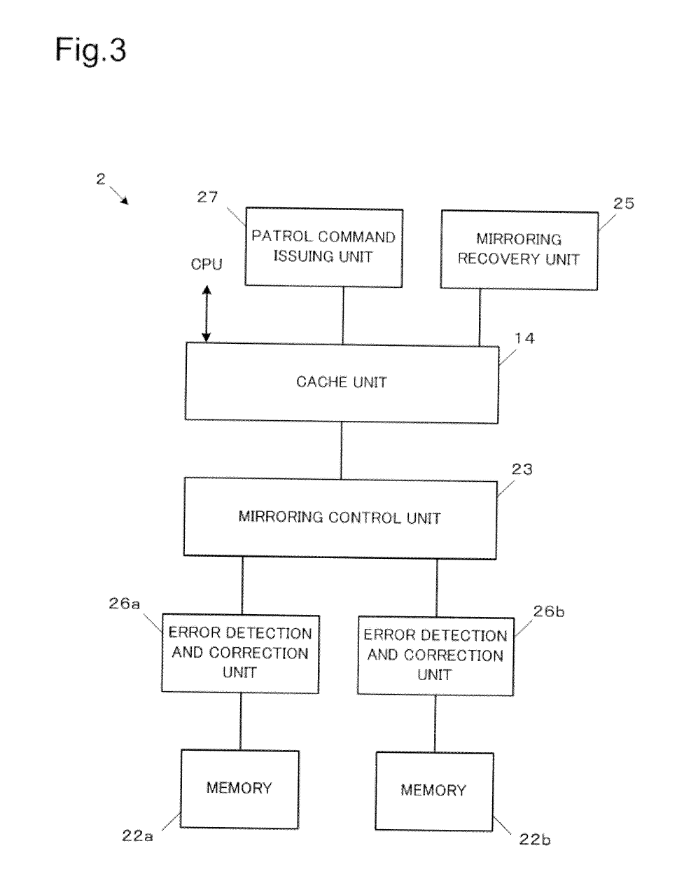

FIG. 3 shows the example of configuration of a mirroring device 2 according to the second exemplary embodiment of the present invention. In FIG. 3, the mirroring device 2 includes a memory 22a, a memory 22b, a mirroring control unit 23, the cache unit 14, a mirroring recovery unit 25, an error detection and correction unit 26a, an error detection and correction unit 26b, and a patrol command issuing unit 27.

The memory 22a and the memory 22b compose a pair of storage devices according to the exemplary embodiment of the present invention. Moreover, the memory 22a and the memory 22b are configured similar to the memory 12a and the memory 12b in the first exemplary embodiment of the present invention, and they store error correction codes (ECC: Error Correcting Code) with data. Further, there is no specific limitation for a selection of ECC in the exemplary embodiment, and as an example, it is created using the error correction coding unit which is not illustrated in the diagram and it may be written to the memory 22a and the memory 22b.

When the error detection and correction unit 26a and the error detection and correction unit 26b detect correctable errors in data which are readout from the memory 22a or the memory 22b, they correct the errors. For example, if SEC-DED (Single Error Correcting-Double Error Detecting Code) is adapted as the error correction code, when the error detection and correction unit 26a or the error detection and correction unit 26b detects 1 bit error in data which are readout from the memory 22a or the memory 22b, it corrects the error. Then, the error detection and correction unit 26a and the error detection and correction unit 26b return the corrected data to the mirroring control unit 23.

And, when the error detection and correction unit 26a and the error detection and correction unit 26b do not detect correctable errors in data readout from the memory 22a and the memory 22b, they return normal data to the mirroring control unit 23.

Moreover, when the error detection and correction unit 26a or the error detection and correction unit 26b detects errors which cannot be corrected in data readout from the memory 22a or the memory 22b, it may notify the mirroring control unit 23 that the data are illegal. For example, in the case that SEC-DED is used as the error correction code, when the error detection and correction unit 26a or the error detection and correction unit 26b detects 2 bits errors in data readout from the memory 22a or from the memory 22b, it notify the mirroring control unit 23 that the data is illegal.

In the normal state, the mirroring control unit 23 duplicates and stores target data to be written to the memory 22a and the memory 22b. That is, when the mirroring control unit 23 receives a write command of data, it issues a write command respectively to the memory 22a and the memory 22b. Then, the mirroring control unit 23 stores the data in response to the write command with the error correction code in the memory 22a and the memory 22b respectively.

And, the mirroring control unit 23 readouts target data to be read from one of the memory 22a or the memory 22b. Specifically, the mirroring control unit 23 transmits a received read command to the memory 22a and the memory 22b. Then, the mirroring control unit 23 respectively receives normal data which is readout from the memory 22a and from the memory 22b, data which the error correction was executed, or information indicating uncorrectable error from the error detection and correction unit 26a and the error detection and correction unit 26b. Then, when the mirroring control unit 23 receives the normal data or the data which the error correction was executed from at least one of the memory 22a or the memory 22b, it returns the normal data or the corrected data to the cache unit 14.

The patrol command issuing unit 27 issues a patrol command for patrolling data. Here, the patrol means a function that the patrol command issuing unit 27 periodically accesses each data stored in the memory 22a and the memory 22b, and recover data in the memory 22a and the memory 22h to normal data based on correcting correctable errors of the data. Specifically, the patrol command issuing unit 27 issues a non-update write command as a patrol command at a predetermined patrol interval to each data in the memory space which correspond to the memory 22a and the memory 22b. That is, the patrol command issuing unit 27 stores normal data which is read from one of the memory 22a or the memory 22b, or data which the error correction was executed by the error detection and correction unit 26a or the error detection and correction unit 26b after it has readout to the cache unit 14. However, the patrol command issuing unit 27 omits reading out data that already exist in the cache unit 14 from the memory 22a and the memory 22b. Further, the cache unit 14 may judge whether it reads or not. Target data in response to a non-update write command are changed into the update completion state by the cache unit 14. Because those data are the update completion state, the cache unit 14 duplicates and rewrites the data that are normal or are already corrected to the memory 22a and the memory 22b via the mirroring control unit 23.

The mirroring recovery unit 25 recovers duplication of data of the memory 22a and the memory 22b using the patrol command issuing unit 27 when the mirroring device 2 recovers from the reduced state to the normal state. And, the mirroring recovery unit 25 may control a patrol interval and adjust a recovery speed of the duplication of data of the memory 22a and the memory 22h when it can control the patrol interval of the patrol command issuing unit 27.

For example, it is supposed that a usual patrol interval of the patrol command issuing unit 27 is set to an interval in a period of from several weeks to several months for completing the patrol process to all memory spaces which correspond to the memory 22a and the memory 22b. An extensive time is required for the mirroring device 2 until it completes the mirroring restoring process, when the mirroring recovery unit 25 uses the patrol command issuing unit 27 with this patrol interval. Therefore, the mirroring recovery unit 25 controls the patrol interval of the patrol command issuing unit 27 as an example so that it can continuously issue the patrol commands.

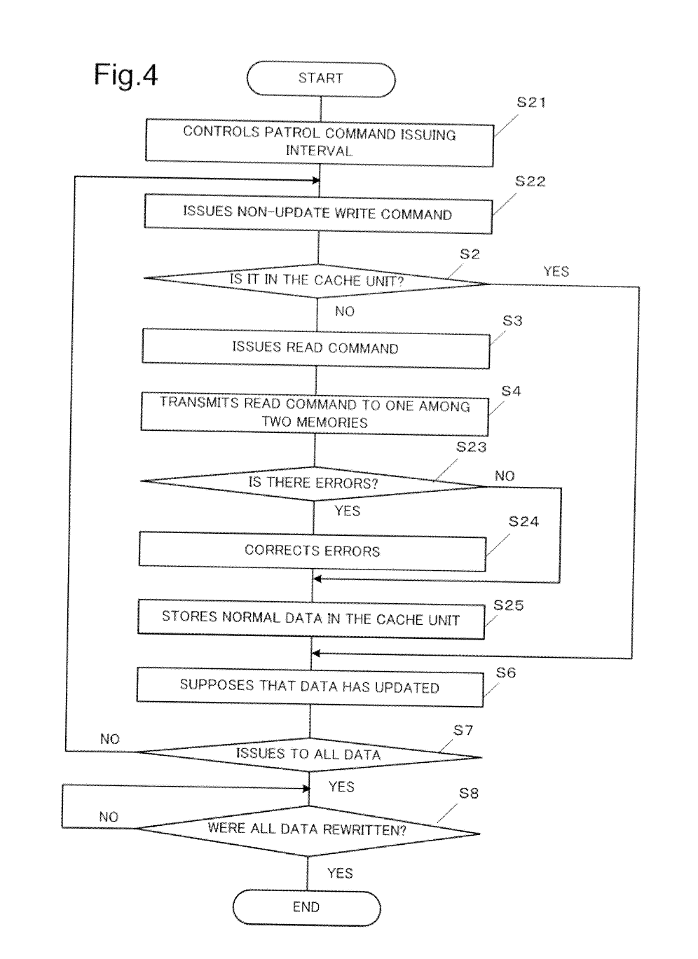

It will describe the mirroring recovery process of the mirroring device 2 in the case that it is configured as is mentioned above with reference to FIG. 4. Further, as an example of the description, it will describe the following processes of the mirroring device 2 when a state is changed from the reduced state where the memory 22b had a failure and it can use the memory 22a to a state where the memory 22b is replaced with a new memory 22b and both the memory 22a and the memory 22b became available. And, the mirroring device 2 also executes processes correspond to reception of read commands and write commands from the CPU during the following processes.

At first, the mirroring recovery unit 25 controls issuing interval of the patrol command of the patrol command issuing unit 27 (Step S21). For example, the mirroring recovery unit 25 controls the patrol command issuing unit 27 so that it can continuously issue the patrol command.

The patrol command issuing unit 27 notifies the cache unit 4 of a non-update write command as a patrol command of data (Step S22).

The mirroring device 2 skips the processes of Steps S3-S4 and S23-S25, when data in response to the non-update write command already exist in the cache unit 14.

The mirroring device 2 executes processes of Steps S2-S4 which are similar to the first exemplary embodiment of the present invention, when the cache unit 14 does not store data in response to the non-update write command (Yes in Step S2). In other words, the cache unit 14 notifies a read command of data to the memory 22a which was being used while it was in the reduced state.

When the error detection and correction unit 26a detects a correctable error in readout data from the memory 22a in response to a read command (Yes in Step S23), it corrects the error (Step S24). Then, the mirroring control unit 23 returns the corrected data to the cache unit 14 (Step S25). On the other hand, when the error is not detected for readout data from the memory 22a, the mirroring control unit 23 returns normal data to the cache unit 14 (Step S25).

Then, the mirroring device 2 repeats the processes of Steps S22, S2-S4, S23-S25 and S6 until it is completed to issue the patrol command for each data in the memory space which correspond to the memory 22a and the memory 22b continuously.

Then, the mirroring device 2 executes processes of Steps S7-S8 which are similar to the first exemplary embodiment of the present invention, and stores data stored in the memory 22a in the reduced state to the cache unit 14. The cache unit 14 rewrites the data to the memory 22a and the memory 22b via the mirroring control unit 23. Thus, the mirroring device 2 completes the processes.

When the recovery of data have been completed, the mirroring recovery unit 25 resets issuing interval of the patrol command of the patrol command issuing unit 27.

It has finished the description of the mirroring recovery processes of the mirroring device 2.

Next, it will describe effects according to the second exemplary embodiment of the present invention.

The mirroring device 2 according to the second exemplary embodiment of the present invention can execute the mirroring restoring process of the duplicated storage device without installing a data copy function nor the competition control function which are dedicated for the mirroring restoring process.

The reason is because, the mirroring device 2 can achieve the data copy function at the time of the mirroring recovery using the patrol command issuing unit 27 which patrols each data in the storage device. That is, the patrol command issuing unit 27 issues a non-update write command which periodically readouts patrol targets data in the storage device. The cache unit 14 receives a normal data or a corrected data which the error detection and correction unit 26a corrected when there is a correctable error in the readout data from the memory 22a based on the non-update write command. Then, the cache unit 14 duplicates and rewrites the normal data or the data which is corrected the error to the pair of storage devices via the mirroring control unit 23. Then, the patrol command issuing unit 27 completes the patrol processes, when all target data in response to the non-update write command are rewritten to the memory 22a and the memory 22b or readout to the cache unit 14. Thus, the patrol command issuing unit 27 can execute the patrol without competing with access to data in the pair of storage devices. Then, the mirroring device 2 according to the second exemplary embodiment of the present invention can execute the mirroring restoring processes of the pair of storage devices using the patrol command issuing unit 27 without installing the data copy function nor the competition control function which are dedicated for the mirroring restoring process.

Moreover, the mirroring device 2 according to the second exemplary embodiment of the present invention can adjust the processing speed of the mirroring recovery using the control of issuing interval of the patrol command the patrol command issuing unit 27 of the mirroring recovery unit 25.

### Third Exemplary Embodiment

Next, it will describe the third exemplary embodiment of the present invention in detail with reference to the drawing. Further, in the drawing referred by the description of the exemplary embodiments, it attaches a same mark to similar elements in the configuration and to steps of the similar processes as the second exemplary embodiment of the present invention, and omits detailed descriptions in the exemplary embodiment.

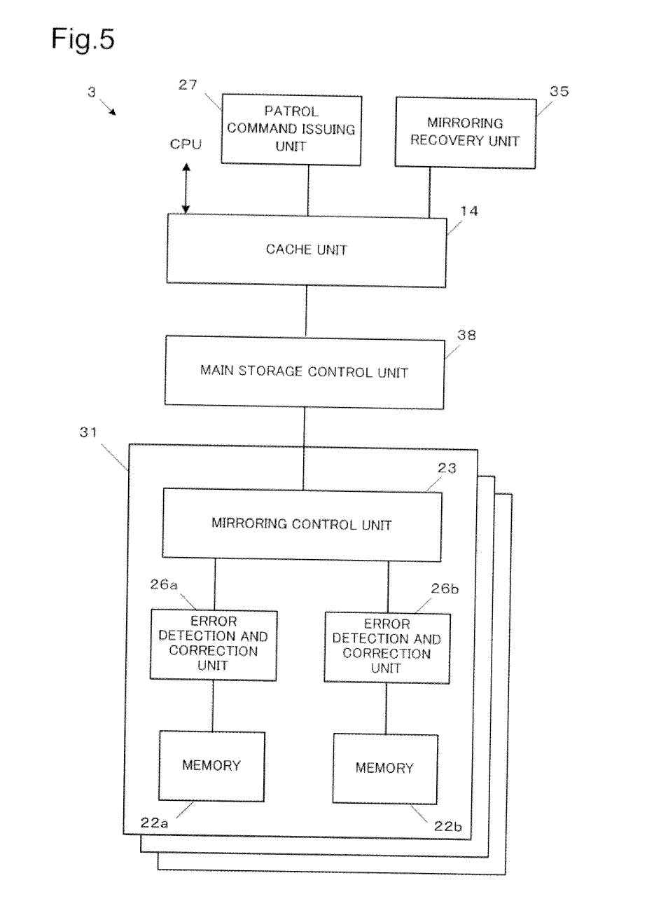

FIG. 5 shows the example of configuration of a mirroring device 3 according to the third exemplary embodiment of the present invention. In FIG. 5, the mirroring device 3 differs from the mirroring device 2 according to the second exemplary embodiment of the present invention in points that it includes a mirroring recovery unit 35 instead of the mirroring recovery unit 25 and includes a plurality of main storage units 31 and a main storage control unit 38 furthermore.

Each main storage unit 31 includes the memory 22a, the memory 22b, the error detection and correction unit 26a, the error detection and correction unit 26b, and the mirroring control unit 23. Further, the memory 22a and the memory 22b, the error detection and correction unit 26a and the error detection and correction unit 26b, and the mirroring control unit 23 are the similar configurations as corresponding elements in the second exemplary embodiment of the present invention.

The main storage control unit 38 executes access to the main storage unit 31 of which the cache unit 14 notifies. For example, the main storage control unit 38 selects the main storage unit 31 correspond to a read command or a write command which are issued by the cache unit 14, and transmits the read command or the write command in addition to data to be written to the selected main storage unit 31. And, the main storage control unit 38 transmits readout data and a result of the command which are returned from the main storage unit 31 in response to the transmitted read command or the write command to the cache unit 14.

The mirroring recovery unit 35 has a similar configuration as the mirroring recovery unit 25 and controls the patrol target of the patrol command issuing unit 27. That is, the mirroring recovery unit 35 controls the patrol command issuing unit 27 so that it issues a non-update write command to the memory 22a and the memory 22b which are the target of the mirroring recovery among a plurality the memory 22a and the memory 22b in the storage device according to the exemplary embodiment.

For example, it is supposed that one of the main storage units 31 is operating in the reduced state and the memory 22a or the memory 22b which could not be used in the main storage unit 31 was replaced with a new memory 22a or the memory 22b. At that time, the mirroring recovery unit 35 controls the patrol command issuing unit 27 so that it sets the main storage unit 31 which includes the replaced memory 22a or memory 22b as the patrol target.

It will describe the mirroring recovery process of the mirroring device 3 which is configured as described above. The mirroring device 3 differs from the mirroring device 2 according to the present invention described using FIG. 4 in a point that it controls the patrol target in addition of issuing interval of the patrol command in Step S21.

In Step S21, the mirroring recovery unit 35 notifies to issue the patrol command continuously for each data in the memory space which correspond to the replaced memory 22a or memory 22b. After that, the mirroring device 3 executes the mirroring recovery based on the similar processes as the mirroring device 2 according to the second exemplary embodiment. Further, according to the exemplary embodiment, in Step S3, the cache unit 14 notifies a read command of data to the target main storage unit 31 via the main storage control unit 38. And, in Step S25, the mirroring control unit 23 returns the target data to the cache unit 14 via the main storage control unit 38.

Next, it will describe an effect according to the third exemplary embodiment of the present invention.

The mirroring device 3 according to the third exemplary embodiment of the present invention can achieve the mirroring restoring process at a higher speed without installing the data copy function or the competition control function which are dedicated for the mirroring restoring process.

The reason is because the mirroring recovery unit 35 controls the patrol command issuing unit 27 so that it sets areas in the storage device as the mirroring recovery target of the patrol. Based on the control, the mirroring device 3 according to the third exemplary embodiment of the present invention recovers the mirroring using the patrol commands for the areas which were in the reduced state. Accordingly, the mirroring recovery unit 35 according to the exemplary embodiment can achieve the mirroring restoring process at higher speed compared with issuing the patrol commands to the entire storage device.

Further, in the exemplary embodiment, it has described as an example that the main storage unit 31 is comprised of the memory 22a and the memory 22b, the error detection and correction unit 26a and the error detection and correction unit 26b, and the mirroring control unit 23. However, the storage device, the error detection and correction unit (26a and 26b), and the mirroring control unit 23 according to the present invention do not have to be included in single configuration. For example, the error detection and correction unit (26a and 26b) and the mirroring control unit 23 can be included in the main storage control unit 38.

And, in each exemplary embodiment of the present invention, it has described the examples where the main storage device was used as the pair of storage devices according to the present invention. However, the present invention is not limited to the described configuration. Each exemplary embodiment of the present invention may apply auxiliary storage devices or storage devices which are located separately at outside via networks as the pair of storage devices according to the present invention. In this case, the cache unit 14 according to the present invention may be configured using the main storage device or typical storage devices which have a cache function.

And, the exemplary embodiments mentioned above can be appropriately combined and can be carried out.

Moreover, the mirroring device of the present invention may be realized with a computer including CPUs, ROMs (Read Only Memory) and RAMs (Random Access Memory). In this case, CPUs of the mirroring device readout programs stored in the ROMs and realize the processes of each part of the mirroring device.

Furthermore, the computer which operates as the mirroring device of the present invention includes storage medium readout devices which readout programs from storage media, and it may execute the processes by reading out the programs from the storage media.

While the invention has been particularly shown and described with reference to the exemplary embodiments thereof, the invention is not limited to these embodiments. It will be understood by those of ordinary skill in the art that various changes in form and details may be made therein without departing from the spirit and scope of the present invention as defined by the claims.

1. A mirroring device, comprising:
a pair of storage devices;
a mirroring control unit which duplicates and stores write data in said pair of storage devices and reads readout data from one of said pair of storage devices in the case of a normal state where both of said pair of storage devices are available, and stores said write data in an available storage device and reads the readout data from said available storage device in the case of a reduced state where it cannot use one of said pair of storage devices;
a cache unit which stores input and output data to said pair of storage devices, reads and stores the data from one of said pair of storage devices via said mirroring control unit in the case that it does not store said readout data, and rewrites the target data to be rewritten in said pair of storage devices via said mirroring control unit; and
a mirroring recovery unit which reads out a data from an available storage device in said reduced state to said cache unit and rewrites the readout data in said pair of storage devices when said mirroring control unit recovers from said reduced state to said normal state and recovers duplication of data.

2. The mirroring device according to claim 1, further comprising:
a pair of error detection and correction units which correct correctable errors of data read from said pair of storage devices; and
a patrol command issuing unit which rewrites normal data or corrected data using said error detection and correction unit after readout from one of said pair of storage devices to said pair of storage devices via said cache unit, wherein
said mirroring recovery unit recovers duplication of said pair of storage devices using said patrol command issuing unit.

3. The mirroring device according to claim 1,
wherein said mirroring recovery unit controls said patrol command issuing unit and adjusts recovery speed of the duplication of said pair of storage devices.

4. The mirroring device according to claim 1,
wherein said mirroring recovery unit executes said recovery of a pair of target areas of mirroring recovery in said pair of storage devices.

5. A mirroring recovery method, comprising:
inputting readout data from and outputting write data to an available storage device in the case of a reduced state where it cannot use one of a pair of storage devices, and duplicating and storing write data in said pair of storage devices and reading readout data from one of said storage devices in the case of a normal state where both of said pair of storage devices are available, and
reading recovery target data to said cache unit from the storage device used in said reduced state, and duplicating and rewriting the data in said cache unit to said pair of storage devices, when there is no said recovery target data in the cache unit which stores the input and output data to said pair of storage devices in the case of recovering from said reduced state to normal state.

6. The mirroring recovery method according to claim 5, further comprising:
correcting a correctable error of said recovery target data which is read from the storage device used in said reduced state and reading in said cache unit when said recovery target data is read in said cache unit.

7. The mirroring recovery method according to claim 5, further comprising:
adjusting a recovery speed of a duplication of said pair of storage devices.

8. The mirroring recovery method according to claim 5, further comprising:
recovering a pair of the areas of the mirroring recovery target in said pair of storage devices.

9. A mirroring device, comprising:
a pair of storage devices;
mirroring control means duplicating and storing write data in said pair of storage devices and reading readout data from one of said pair of storage devices in the case of a normal state where both of said pair of storage devices are available, and storing said write data in an available storage device and reading the readout data from said available storage device in the case of a reduced state where it cannot use one of said pair of storage devices;
cache means storing input and output data to said pair of storage devices, reading and storing the data from one of said pair of storage devices via said mirroring control means in the case that it does not store said readout data, and rewriting the target data to be rewritten in said pair of storage devices via said mirroring control means; and
mirroring recovery means reading out a data from an available storage device in said reduced state to said cache means and rewriting the readout data in said pair of storage devices when said mirroring control means recovering from said reduced state to said normal state and recovering duplication of data.
